(19) United States
(12) Patent Application Publication
(10) Pub. No.: US 2009/0230123 A1
(43) Pub. Date: Sep. 17, 2009

(54) DEVICE AND METHOD FOR DRIVING THE INDUCTION HEATING MEANS OF AN INDUCTION HOB

(75) Inventors: Christian Egenter, Bretten (DE); Thomas Haag, Oberhausen-Rheinhausen (DE); Wilfried Schilling, Kraichtal (DE); Sebastian Stadtmuller, Ubstadt (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: E.G.O. Elektro-Geraetebau GmbH

(21) Appl. No.: 12/403,727

(22) Filed: Mar. 13, 2009

(30) Foreign Application Priority Data
Mar. 14, 2008 (DE) 10 2008 015 036.3

(51) Int. Cl. H05B 6/04

(52) U.S. Cl. 219/660

(57) ABSTRACT

A device for driving the induction heating coils of an induction hob, in which power is supplied to the induction heating coils via the electric power grid or a grid phase thereof, comprises a filter unit and a rectifier unit with at least one converter and intermediate circuit. For two induction heating coils, one rectifier unit and two converters are connected to one filter unit. For further induction heating coils, an additional converter is coupled downstream of one of the existing filter units.

### CROSS REFERENCE TO RELATED APPLICATIONS

This application claims priority to DE 10 2008 015 036.3, filed on Mar. 14, 2008, the contents of which are incorporated by reference.

### FIELD OF THE INVENTION

The invention relates to a device and a method for driving or supplying power to the induction heating means of an induction hob, called induction coils herein. Power is supplied to these induction heating means via the electric power grid or a grid phase thereof, a filter unit being provided thereon and a rectifier unit with at least one converter and one intermediate circuit being provided on the filter unit. In one case, a rectifier unit, with in each case having two converters in the rectifier unit, is advantageously connected to a filter unit, such that one induction heating means is driven or is supplied with power per converter.

### BACKGROUND OF THE INVENTION

Conventional induction generators or previously described devices for hobs are optimized for two or four induction coils or cooking rings. Devices with one or three cooking rings are produced by omitting one converter or by operating a two-circuit cooking zone using twin converters. Systems with four rings are produced by parallel construction of two twin units. Five or six ring systems accordingly use three twin units or a quad unit together with a twin unit.

A generator contains in principle the converters, which produce the high frequency, and a filter. Filters and converters may be constructed on a printed circuit board or separately, but one converter unit with one or more induction coils, typically two induction coils, is always allocated to one filter unit. Each filter unit may be connected separately to one grid phase. If fewer grid phases are available than filter units, the filter units are always connected together on the grid side.

It is additionally known for an individual converter to be connected alternately by means of relay switching to a plurality of induction coils or a plurality of heating circuits of one induction coil. It is likewise known for two or more converters, which may even be located in different converter units, to be permanently connected to different sub-coils of a multi-circuit induction coil.

In the case of alternate use of a converter for two induction coils, it is possible to cut down on one converter. Then, however, it is only ever possible for one induction coil to be supplied with power at any one time.

If the converter is alternately connected at short intervals to the two induction coils, as known from EP 286044 A2, disadvantages arise with regard to cooking performance, such as for example water may go on and off the boil. Furthermore, mechanical switching of the relay brings about regular troublesome clicking noises. The flickering, which arises on switching, is also disadvantageous.

On the other hand, if the converter is firmly allocated to one induction coil via a relay, as is known from EP 1194008 A2 and U.S. Pat. No. 7,227,103 A1, such that a further induction coil is completely without a converter connection, the induction coil cannot be supplied with power and the corresponding ring remains cold. An advantage of this solution is that no regularly occurring clicking noise arises and the operating noise is quieter, provided that the two converters of the multi-circuit induction heating means are frequency-synchronized with one another.

The problem on which the present invention is based is that of providing an above-mentioned device and a method for supplying power to or driving induction heating means, with which prior art problems may be avoided and in particular a further induction heating means may advantageously be driven with the least possible effort.

### BRIEF DESCRIPTION OF THE DRAWINGS

Exemplary embodiments of the invention are illustrated schematically in the drawings and explained in more detail below. In the drawings:

FIG. 1 shows a representation of the connection of an additional rectifier unit for an additional induction heating means via switching means to the two existing filter units,

FIG. 2 shows a modification of the representation of FIG. 1 with connection via the switching means to the intermediate circuits of two existing rectifier units,

FIG. 3 shows the connection of an additional induction heating means in the form of a two-circuit coil with one induction coil connected to an existing rectifier unit and the other induction coil to an additional converter,

FIG. 4 shows a further modification, in which an additional twin converter unit is connected via switching means to intermediate circuits of two existing rectifier units for two additional induction heating means and

FIG. 5 shows a modification of the representation of FIG. 4, in which two separate additional converters for in each case one additional induction heating means are connected via in each case their own switching means to the two intermediate circuits of the two existing rectifier units.

### DETAILED DESCRIPTION OF EXEMPLARY EMBODIMENTS

This problem is solved in one embodiment by a device having the features of claim 1 and a method having the features of claim 13. Advantageous and preferred configurations of the invention are the subject matter of the further claims and are explained in greater detail below. Some of the features listed below are described only with reference to the device or only with reference to the method. However, they may apply irrespectively both to the device and to the method. The wording of the claims is incorporated by express reference into the content of the description.

The invention provides for an additional converter, which is connected downstream of one of the existing filter units, to be provided for a further induction heating means, which is designed to be driven by the device or the method and supplied with power. According to one embodiment of the invention, no further filter unit is therefore provided for an additional converter of a further induction heating means even if the filter units are in themselves already fully occupied, but rather this additional converter is connected downstream thereof. In an advantageous configuration of the invention, a total of two filter units are provided, each of them supplying one rectifier unit having in each case two converters. An existing induction heating means is connected to each of these converters.

In a basic configuration of one embodiment of the invention the additional converter may be connected, in particular directly connected, without a rectifier to an intermediate circuit of an existing rectifier unit connected to the filter unit. Moreover, this connection may again be effected via switching means as previously described. In a still further embodiment of the invention, the additional converter may be connected without a rectifier via switching means to a plurality of intermediate circuits of a plurality of rectifier units. Varying power supply of the additional converter via the connection from various intermediate circuits may proceed according to the same principles as described before for connection of the additional converter to a filter unit.

Furthermore, it is also possible with the above-stated configuration of the invention not only for one additional converter for one additional induction heating means, but rather for a plurality of additional converters for in each case one additional induction heating means, to be connected to the intermediate circuits of existing rectifier units. This may advantageously again proceed via switching means, since this is an advantageous possibility for power supply from a plurality of rectifier units or a plurality of filter units.

In another embodiment of the invention, provision may be made for the additional converter for the additional induction heating means to be connected, together with a rectifier unit for it, between a filter unit and an existing rectifier unit with converters. In particular, the additional converter may here be connected directly to a connection between filter unit and rectifier unit. In this case, it is advantageously possible to connect the additional converter via a switching means, for example a relay, to such a connection between filter unit and rectifier unit. It is particularly advantageously possible to connect the additional converter via the switching means not just to one connection between one filter unit and one rectifier unit, but rather to the connections between a plurality of filter units and in each case their firmly associated rectifier units. It is thus possible, as is explained below in greater detail, for the additional converter as it were to be connected via the switching means, to one or another filter unit, depending on the reserve capacity of the filter unit still available. In particular, the additional converter for the additional induction heating means may in each case be connected to that filter unit which at that moment has a lower power output for its existing induction heating means, i.e., still a relatively large reserve capacity.

In this case it is moreover still possible, if even this filter unit under lower load has insufficient residual power, for the additional induction heating means to be operated with reduced power, so as to comply with a maximum admissible power, in particular also a temporarily maximum admissible power, of the filter unit. In a still further configuration of the invention, such a power reduction may indeed mainly take place at the additional induction heating means, but additionally also at one of the existing induction heating means of the filter unit. In this way, the virtually absolutely necessary power reduction may be spread over a plurality of induction heating means, such that it does not have a particularly significant or negative effect on any of them. Possible methods of achieving such a power reduction are known to a person skilled in the art from DE 10 2005 045 875 A1, the content of which in this regard is hereby incorporated by express reference into the content of the present description.

In a further embodiment of the invention, it is possible to apply power in such a way to additional heating means, which in each case comprise two or even more associated induction coils as “two-circuit heating means” or “multi-circuit heating means”, wherein the power for a first induction coil comes from an existing first rectifier unit. For a second or further induction coil, which is advantageously a heating means usually connectable to the first induction coil, the power may come from a previously described additional converter, which is connected by switching means to one of the intermediate circuits of the existing rectifier units. Alternatively, power may be supplied to the second induction coil via an additional converter with rectifier unit, which is connected to an existing filter unit.

In a still further embodiment of the invention, provision may advantageously be made for the converters to be operated in a frequency-synchronized manner. In this way, interference noise between the induction heating means may be avoided.

These and further features follow not only from the claims but also from the description and the drawings, the individual features being realized in each case alone or several together in the form of sub-combinations in an embodiment of the invention and in other fields and may constitute advantageous, per se protectable embodiments, for which protection is here claimed. Subdivision of the application into individual sections and intermediate headings does not limit the general applicability of the statements made thereunder.

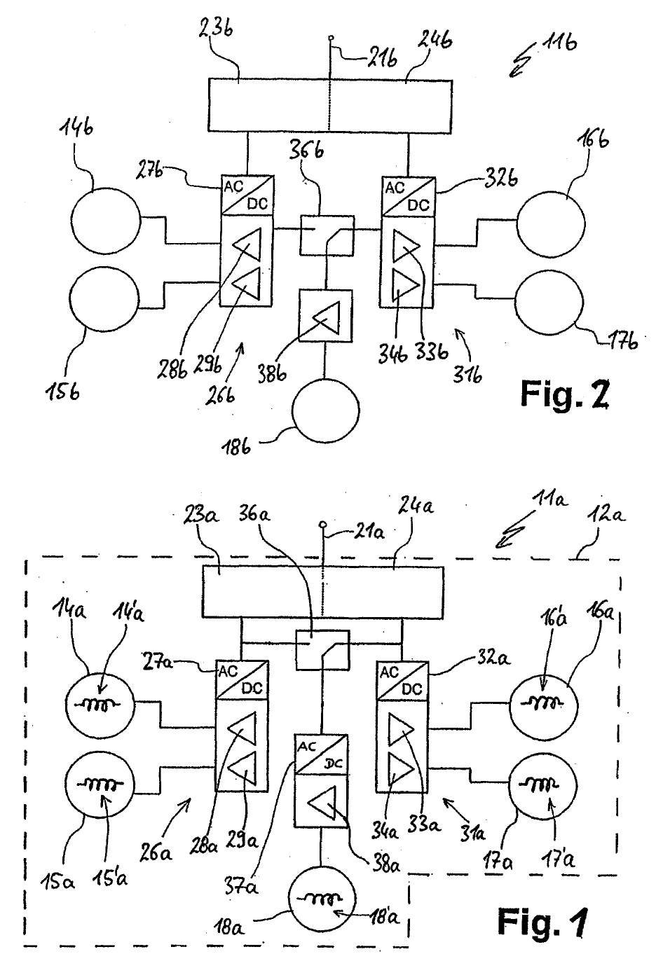

FIG. 1 shows a device 11a for driving induction heating means 14a to 17a. These induction heating means 14a to 17a are constituent parts of an induction hob 12a represented by broken lines, as is known in principle for example from the above-mentioned U.S. Pat. No. 7,227,103 A1. The induction heating means 14a to 17a in each case comprise schematically illustrated induction coils 14′a to 17′a or are formed thereof This construction does not present any problem to a person skilled in the art.

The device 11a comprises two filter units 23a and 24a, which are connected to an electric power grid 21, in particular a two-phase electric power grid. Although the filter units 23a and 24a are illustrated as belonging together, they may be separate components or structural units. Advantageously and conventionally, they are arranged on the same printed circuit board or in the same housing. A first rectifier unit 26a is connected to the left-hand filter unit 23a. This comprises a rectifier 27a, which powers two converters 28a and 29a, and does this via an intermediate circuit which is not shown, which is conventionally achieved in this way however and is also revealed by the above-stated prior art. The converter 28a powers the induction heating means 14a and the converter 29a powers the induction heating means 15a or the converters are each responsible for power supply of the induction heating means.

The right-hand filter unit 24a accordingly powers a second rectifier unit 31a having a rectifier 32a and two converters 33a and 34a, which in turn supply the induction heating means 16a and 17a with power. To this extent, the device described corresponds to the prior art for driving the four induction heating means 14a to 17a via four converters 28a, 29a, 33a and 34a.

However, if in the case of the induction hob 12a an additional induction heating means 18a with corresponding induction coil 18′a needs to be supplied with power, this is per se difficult. It could be connected via a switching means to an output of one of the converters, but then the other induction heating means usually supplied by this converter could no longer be supplied with power.

Therefore, according to one embodiment of the invention, a switching means 36a is connected to the connections between the two rectifier units 26a and 31a and their respective filter units 23a and 24a, i.e. downstream of the filter units. The switching means 36a may connect to the supply of one of the filter units, depending on the power requirements at the time. The switching means 36a powers an additional converter 38a. This in turn ensures power supply for the additional induction heating means 18a. In the case illustrated in FIG. 1 the switching means 36a is connected to the right-hand filter unit 24a. This means that the total power needed by the induction heating means 16a, 17a and 18a may not be above the maximum total power which the filter unit 24a can make available, for example even in the short term. In this case, the above-described methods of sharing power between the three induction heating means take effect, the latter being in each case adjusted by the converters 33a, 34a and 38a. Alternatively, in the case of an overloaded filter unit 24a, it is possible to switch to the left-hand filter unit 23a, which may still have reserves.

An additional converter thus connects via the switching means in principle to the filter unit or rectifier unit, which is more suitable at that moment. By means of frequency or phase control, the desired power of each induction heating means may be adjusted by the converter.

FIG. 2 shows a modification of the device from FIG. 1 as device 11b. The difference is that the additional switching means 36b is no longer connected directly to the filter units 23b and 24b, but rather to the intermediate circuits (not shown) of the first rectifier unit 26b and the second rectifier unit 31b. This means that then the additional rectifier according to FIG. 1 is no longer necessary either, since connection takes place directly to the intermediate circuits of the existing rectifier units. Otherwise, the function and use of the switching means 36 is the same as before. In addition, however, it is also still necessary to take account of the maximum available total power of the rectifier units or indeed of the associated intermediate circuits.

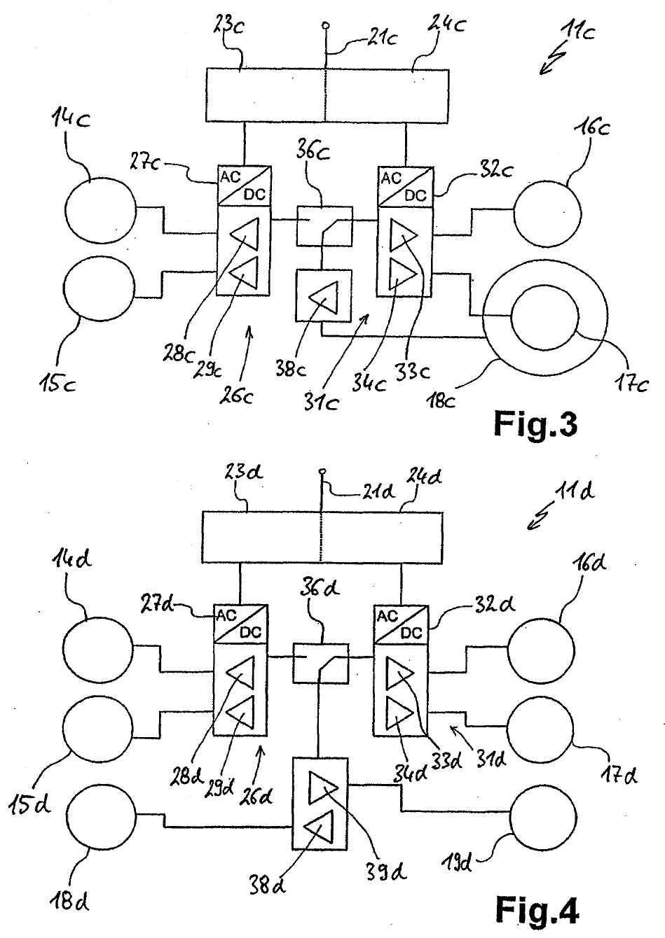

FIG. 3 shows a further modification of a device 11c, which again corresponds substantially to that of FIG. 2, i.e. with the additional switching means 36c connected to the intermediate circuits of the first rectifier unit 26c and second rectifier unit 31c. Furthermore, in FIG. 3 the existing induction heating means 17c or the corresponding induction coil is the inner part of a two-circuit heating means. The outer part surrounding the inner part is formed by the additional induction heating means 18c with the corresponding induction coil. This additional induction heating means 18c is powered by an additional converter 38c. Although, in the case of an induction hob, the two induction heating means 17c and 18c thus form virtually the same cooking ring, they are powered from different converters and, if the additional converter 38c is connected to the left-hand rectifier unit 26c via the switching means 36c, even via different filter units and different rectifier units. Precisely in this case, however, the distribution of power may be advantageous, since in the case of two-circuit operation of the two-circuit heating unit a large amount of power is required and then the induction heating means 16c belonging to the same rectifier unit 31c could probably not be operated or only with very low power. Otherwise, the same power distribution rules apply here as previously described.

In the further device 11d according to FIG. 4, two additional converters 38d and 39d are connected to a switching means 36d. In this case the additional converter 38d powers the additional induction heating means 18d and the additional converter 39d powers the additional induction heating means 19d. Thus an induction hob may here be constructed with six induction heating means 14d to 19d and thus also six cooking rings. The two additional induction heating means 18d and 19d may thus be connected via additional converters 38d and 39d and the switching means 36d to one of the intermediate circuits of the existing rectifier units 26d and 31d. In this respect, power management is precisely here also of great importance.

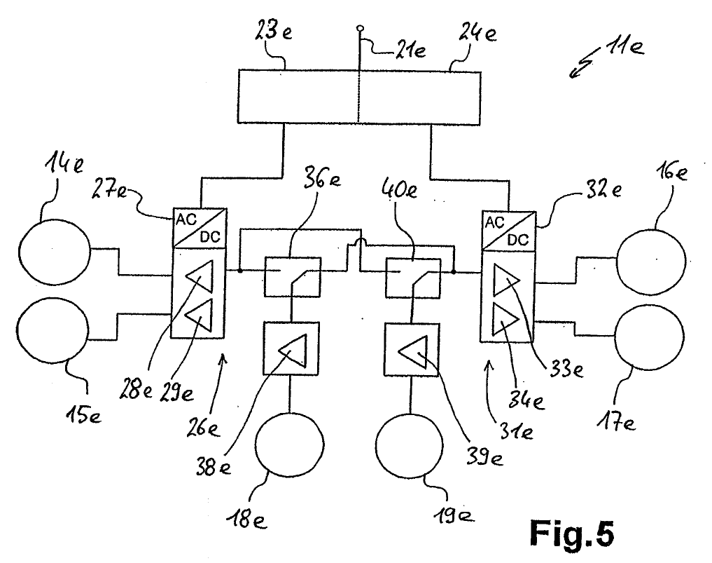

FIG. 5 finally shows a device 11e. In a modification of the device of FIG. 4, two additional switching means 36e and 40e are provided here, which are connected in each case to two intermediate circuits of the existing rectifier units 26e and 31e. The switching means 36e is connected to an additional converter 38e, which powers an additional induction heating means 18e from the intermediate circuit of one of the rectifier units. The additional switching means 40e connects the additional converter 39e to one of the intermediate circuits of the existing rectifier units to supply power to the additional induction heating means 19e.

With the device 11e according to FIG. 5, it is thus more advantageously possible than with the device 11d in FIG. 4 for each of the converters 38e and 39e for the induction heating means 18e and 19e to be connected as required via the switching means 36e and 40e to one of the intermediate circuits of the existing rectifier units 26e and 31e. In this respect it is also possible for both converters 38e and 39e to be connected to the same intermediate circuit, if this is allowed by the adjusted powers and the reserve capacities of the relevant rectifier unit.

1. A device for driving induction heating means of an induction hob, electric power being supplied to said induction heating means via an electric power grid or a grid phase of said electric power grid, a filter unit and a rectifier unit with at least one converter and an intermediate circuit, wherein for two said induction heating means one said rectifier unit and at least one said converter being connected to one said filter unit, wherein for a further induction heating means an additional converter is coupled downstream of one of said existing filter units.

2. The device as claimed in claim 1, wherein for two said induction heating means one said rectifier unit and two said converters are connected to one said filter unit.

3. The device as claimed in claim 1, wherein a total of two said filter units are provided, each having one said rectifier unit with in each case two said converters for in each case one said induction heating means per said converter.

4. The device as claimed in claim 1, wherein said additional converter is connected without a rectifier directly to an intermediate circuit of an existing rectifier unit with converter.

5. The device as claimed in claim 4, wherein said additional converter is connected without a rectifier directly via switching means to a plurality of said intermediate circuits of said rectifier units with said converters.

6. The device as claimed in claim 4, wherein a plurality of said additional converters are connected to said intermediate circuits of a plurality of said rectifier units, each additional converter being connected via switching means to said intermediate circuits of all said rectifier units.

7. The device as claimed in claim 1, wherein said additional converter is connected, together with a rectifier unit, directly to a connection between a filter unit and existing rectifier units with converters.

8. The device as claimed in claim 7, wherein said additional converter is connected, together with a rectifier unit, directly to a connection between a filter unit and existing rectifier units with converters via switching means to connections of a plurality of said filter units with in each case one said rectifier unit.

9. The device as claimed in claim 1, wherein said electric power is applied to additional induction heating means with two associated induction coils in such a way that for a first induction coil said electric power comes from an existing rectifier unit and for a second induction coil, which is an additional induction coil to said first induction coil, said electric power comes from an additional converter with switching means, said switching means being connected to one of said intermediate circuits of said existing rectifier units.

10. The device as claimed in claim 1, wherein an additional converter is designed so as to connect said additional induction heating means to that filter unit, which is producing relatively low power at that moment.

11. The device as claimed in claim 10, wherein, if said residual power of said filter unit is insufficient for said additional induction heating means, said additional induction heating means is being operated with reduced power while complying with a maximum power of said filter unit.

12. The device as claimed in claim 1, wherein all said converters are frequency-synchronized so as to avoid interference noise between said induction heating means.

13. A method of driving induction heating means of an induction hob, electric power being supplied to said induction heating means via an electric power grid or a grid phase thereof, a filter unit and a rectifier unit with at least one converter and intermediate circuit, wherein for two said induction heating means one said rectifier unit and at least one said converter being connected to one said filter unit, wherein for a further induction heating means of said induction hob an additional converter is coupled downstream of one of said existing filter units.

14. The method as claimed in claim 13, wherein for two said induction heating means one said rectifier unit and two said converters are connected to one said filter unit.

15. The method as claimed in claim 13, wherein a total of two said filter units are provided, each having one said rectifier unit with in each case two said converters for in each case one said induction heating means per said converter.

16. The method as claimed in claim 13, wherein said additional converter is connected without a rectifier directly via switching means to a plurality of said intermediate circuits of said rectifier units with said converters.

17. The method as claimed in claim 16, wherein a plurality of said additional converters are connected to said intermediate circuits of a plurality of said rectifier units.

18. The method as claimed in claim 17, wherein each said additional converter is connected via switching means to said intermediate circuits of all said rectifier units.

19. The method as claimed in claim 13, wherein said additional converter is connected, together with a rectifier unit, to a connection between a filter unit and existing rectifier units with said converters.

20. The method as claimed in claim 19, wherein said additional converter is connected, together with a rectifier unit, via switching means to connections of a plurality of said filter units with in each case one said rectifier unit.

21. The method as claimed in claim 13, wherein said electric power is applied to additional said induction heating means with two induction coils in such a way that for one said induction coil said electric power comes from an existing rectifier unit and for said other induction coil, which is an additional induction coil, said electric power comes via an additional converter with switching means connected to one of said intermediate circuits of said existing rectifier units.

22. The method as claimed in claim 13, wherein an additional converter connects said additional induction heating means to that filter unit, which at that moment is producing relatively low power, said additional induction heating means being operated with reduced power while complying with a maximum power of said filter unit if said residual power of said filter unit is insufficient for said additional induction heating means.

23. The method as claimed in claim 13, wherein all said converters are frequency-synchronized so as to avoid interference noise between said induction heating means.
